(19) United States
(12) Patent Application Publication
(10) Pub. No.: US 2020/0041651 A1
(43) Pub. Date: Feb. 6, 2020

(54) SYSTEM AND METHOD FOR IMPROVING RANGE RESOLUTION IN A LIDAR SYSTEM

(71) Applicant: ANALOG DEVICES, INC., NORWOOD, MA (US)

(72) Inventors: Ronald A. Kapusta, Carlisle, MA (US); Jianrong Chen, Andover, MA (US)

(21) Appl. No.: 16/051,096

(22) Filed: Jul. 31, 2018

(51) Int. Cl. G01S 17/93; G01S 17/42; G01S 7/481; G01S 13/93

(52) U.S. Cl. CPC G01S 17/93; G01S 13/93; G01S 7/4817; G01S 17/42

(57) ABSTRACT

A shape of a transmitted LIDAR pulse can be measured contemporaneously with operation of the LIDAR system, such as to account for variations in the shape of the LIDAR pulse, such as due to changes in environmental or operation conditions. The measured shape can then be used to determine an arrival time of LIDAR pulses received from a target region with improved accuracy.

### FIELD OF THE DISCLOSURE

This document pertains generally, but not by way of limitation, to estimation of distance between a detection system and a target, using an optical transmitter and an optical receiver.

### BACKGROUND

In an optical detection system, such as a system for providing light detection and ranging (LIDAR), various automated techniques can be used for performing depth or distance estimation, such as to provide an estimate of a range to a target from an optical assembly, such as an optical transceiver assembly. Such detection techniques can include one or more “time-of-flight” determination techniques. For example, a distance to one or more objects in a field of view can be estimated or tracked, such as by determining a time difference between a transmitted light pulse and a received light pulse.

### SUMMARY OF THE DISCLOSURE

LIDAR systems, such as automotive LIDAR systems, may operate by transmitting one or more pulses of light towards a target region. The one or more transmitted light pulses can illuminate a portion of the target region. A portion of the one or more transmitted light pulses can be reflected and/or scattered by the illuminated portion of the target region and received by the LIDAR system. The LIDAR system can then measure a time difference between the transmitted and received light pulses, such as to determine a distance between the LIDAR system and the illuminated portion of the target region. The distance can be determined according to the expression

$$d = \frac{tc}{2} ,$$

where d can represent a distance from the LIDAR system to the illuminated portion of the target, t can represent a round trip travel time, and c can represent a speed of light. However, more than one pulse may be received from the illuminated portion of the target for a single transmitted pulse, such as due to a surface of one or more objects in the illuminated portion of the target region.

Over time, a shape of the transmitted pulse may vary, such as due to varying environmental parameters such as temperature, pressure, or humidity. The shape of the pulse can also vary over time, such as due to aging of the LIDAR system. The inventors have recognized, among other things, that it may be advantageous to measure a shape of the transmitted pulse contemporaneously with the transmitted pulse, such as to account for variations in the shape of the transmitted pulse. The measured shape of the transmitted pulse can then be used to provide improved accuracy in the determination of an arrival time of the received pulse reflected or scattered from the illuminated portion of the target region.

In an example, a technique (such as implemented using an apparatus, a method, a means for performing acts, or a device readable medium including instructions that, when performed by the device, can cause the device to perform acts) can include improving range resolution in an optical detection system, the technique including transmitting a first light pulse towards a target region using a transmitter, receiving a first portion of the first transmitted light pulse from the transmitter and determining a temporal profile of the first transmitted light pulse from the received first portion, and receiving a second portion of the first transmitted light pulse from the target region and determining an arrival time of the second received portion from the target region based at least in part on the determined temporal profile of the first transmitted light pulse.

In an example, an optical detection system can provide improved range resolution, the system comprising a transmitter configured to transmit a light pulse towards a target region, a receiver configured to receive a first portion of the transmitted light pulse from the transmitter, and control circuitry configured to determine a temporal profile of the transmitted light pulse from the received first portion, wherein the receiver is configured to receive a second portion of the transmitted light pulse from the target region and the control circuitry is configured to determine an arrival time of the second received portion from the target region based at least in part on the determined temporal profile of the transmitted light pulse.

This summary is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates an example comprising a LIDAR system.

FIG. 2A illustrates an example comprising a LIDAR system.

FIG. 2B illustrates an example comprising received pulses in a LIDAR system.

FIG. 3A and FIG. 3B illustrate aspects of an example relating to operation of a LIDAR system.

FIG. 4 illustrates an example relating to operation of a LIDAR system.

FIG. 5 illustrates an example relating to operation of a LIDAR system.

FIG. 6 illustrates an example relating to operation of a LIDAR system.

FIG. 7 illustrates an example relating to a method of operation of a LIDAR system.

FIG. 8 illustrates an example comprising a system architecture and corresponding signal flow, such as for implementing a LIDAR system.

### DETAILED DESCRIPTION

LIDAR systems, such as automotive LIDAR systems, may operate by transmitting one or more pulses of light towards a target region. The one or more transmitted light pulses can illuminate a portion of the target region. A portion of the one or more transmitted light pulses can be reflected and/or scattered by the illuminated portion of the target region and received by the LIDAR system. The LIDAR system can then measure a time difference between the transmitted and received light pulses, such as to determine a distance between the LIDAR system and the illuminated portion of the target region. The distance can be determined according to the expression

$$d = \frac{tc}{2} ,$$

where d can represent a distance from the LIDAR system to the illuminated portion of the target, t can represent a round trip travel time, and c can represent a speed of light.

More than one pulse may be received in response to a single transmitted pulse, for example due to multiple objects in the illuminated portion of the target region. The shape of the received pulse may also be distorted, for example if the surface of the reflecting object is not oriented orthogonally to the LIDAR system. Additionally, the shape of the transmitted pulse may vary, such as due to varying environmental parameters such as temperature, pressure, or humidity. The shape of the pulse can also vary over time, such as due to aging of the LIDAR system. The inventors have recognized, among other things, that it may be advantageous to measure a shape of the transmitted pulse, such as contemporaneously with generation or transmission of the pulse, such as to account for variations in the shape of the transmitted pulse. The measured shape of the transmitted pulse can then be used to provide improved accuracy in the determination of an arrival time of the received pulse reflected or scattered from the illuminated portion of the target region.

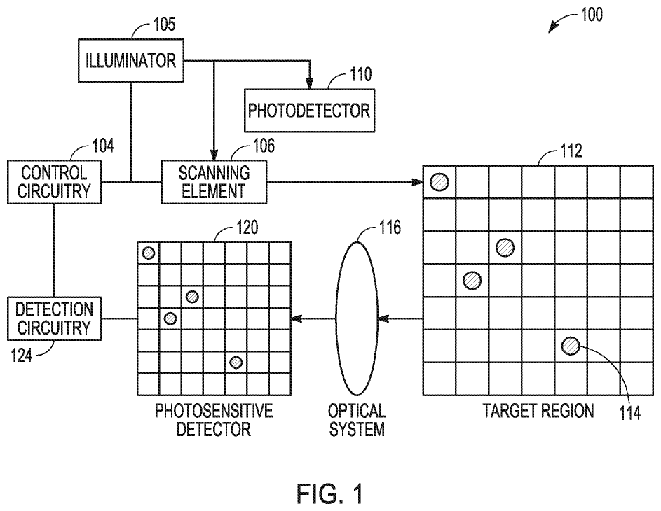

FIG. 1 shows an example of a LIDAR system 100. The LIDAR system 100 can include control circuitry 104, an illuminator 105, a scanning element 106, a photodetector 110, an optical system 116, a photosensitive detector 120, and detection circuitry 124. The control circuitry 104 can be connected to the illuminator 105, the scanning element 106 and the detection circuitry 124. The photosensitive detector 120 can be connected to the detection circuitry 124. During operation, the control circuitry 104 can provide instructions to the illuminator 105 and the scanning element 106, such as to cause the illuminator 105 to emit a light beam towards the scanning element 106 and to cause the scanning element 106 to direct the light beam towards the target region 112. A portion of the light beam emitted by the illuminator 105 can be collected by the photodetector 110, such as to provide an indication of a temporal shape of the emitted light beam versus time (e.g., to provide a time-domain representation of the emitted light beam). In an example, the illuminator 105 can include a laser and the scanning element can include a vector scanner, such as an electro-optic waveguide. The scanning element 106 can adjust an angle of the light beam based on the received instructions from the control circuitry 104. The target region 112 can correspond to a field of view of the optical system 116. The scanning element 106 can scan the light beam over the target region 112 in a series of scanned segments 114.

The optical system 116 can receive at least a portion of the light beam from the target region 112 and can image the scanned segments 114 onto the photosensitive detector 120 (e.g., a CCD). The detection circuitry 124 can receive and process the image of the scanned points from the photosensitive detector 120, such as to form a frame. A distance from the LIDAR system 100 to the target region 112 can be determined for each scanned point, such as by determining a time difference between the light transmitted towards the target region 112 and the corresponding light received by the photosensitive detector 120. In an example, the LIDAR system 100 can be installed in an automobile, such as to facilitate an autonomous self-driving automobile. In an example, the LIDAR system 100 can be operated in a flash mode, where the illuminator 105 can illuminate the entire field of view without the scanning element 106.

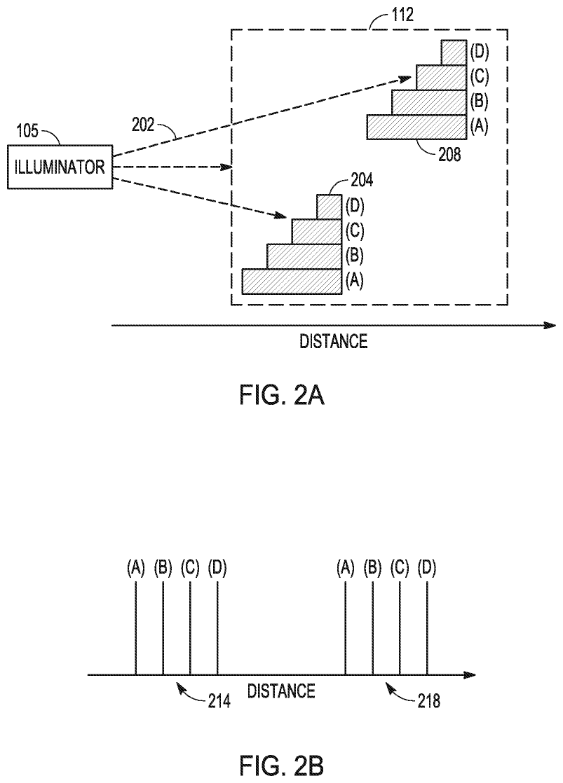

FIG. 2A illustrates an example of a light beam 202 that can be transmitted by the illuminator 105 and incident upon the target region 112. The target region 112 can include a first feature 204 and a second feature 208. The first feature 204 can include four surfaces 204(a), 204(b), 204(c), and 204(d), and the second feature 208 can include four surfaces 208(a), 208(b), 208(c), and 208(d). Each of the surfaces 204(a)-204(d) and 208(a)-208(d) can correspond to a different distance between the target region 112 and the LIDAR system 100. In FIG. 2B, pulses of light 214(a), 214(b), 214(c), and 214(d,) and 218(a), 218(b), 218(c), and 218(d) correspond respectively to each of the surfaces 204(a)-204(d) and 208(a)-208(d) shown in FIG. 2A. Such pulses can be received by the photosensitive detector 120. Pulses of light arriving at the photosensitive detector 120 from different surfaces, can have different round trip travel times. The different round trip travel times can correspond to different distances between the LIDAR system and the target region 112. In the example illustrated in FIGS. 2A and 2B, the pulses received by the photosensitive detector might be easily distinguished from one another, such as due to a pulse width being substantially less in duration than a delay associated with spacing between adjacent pulses.

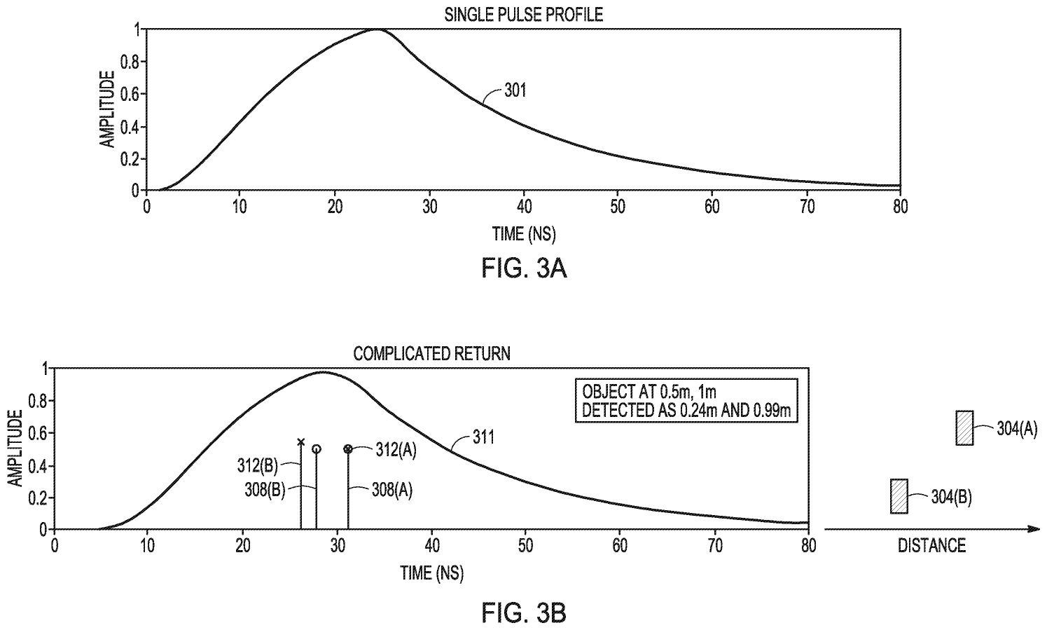

FIG. 3A and FIG. 3B illustrate an example where a pulse width can be larger than a spacing between received pulses. FIG. 3A illustrates an example of a profile 301 of a single pulse. The pulse width as illustrated in FIG. 3A can have a width (e.g., full width at half max) of about 25 nanoseconds. FIG. 3B illustrates an example of a temporal profile 311 corresponding to two received pulses, with a time between received pulses of about 3.33 ns, corresponding to a distance between features 304(a) and 304(b) of the target region 112 of about 0.5 meters (m). A distance between a feature of the target region 112 and the LIDAR system 100 can be determined according to the expression

$$= \frac{tc}{2} ,$$

where d can represent a distance from the LIDAR system to the feature of the target region 112, t can represent a round trip travel time, and c can represent a speed of light.

The photodetector 110 can detect a portion of each of the outgoing pulses, such as to determine a temporal shape of each of the outgoing pulses. The outgoing pulses can be scattered by the features 304(a) and 304(b) in the target region 112. The control circuitry 104 can then use the determined temporal shapes to determine an arrival time of each of the detected pulses, where the detected pulses can correspond to a received portion of the outgoing pulse scattered or reflected from features 304(a) and 304(b). Markers 308(a) and 308(b) can represent the distance from the LIDAR system 100 to the features 304(a) and 304(b), respectively. In an example, the control circuitry can use a matched filter to determine the arrival time of each of the detected pulses. One or more parameters of the matched filter can be updated based on the determined temporal shapes. The first feature of the target region 304(a) can correspond to a first distance from the LIDAR system, and the second feature of the target region 304(b) can correspond to a second distance from the LIDAR system. The control circuitry can determine a first distance 312(a) corresponding to the first received pulse and a second distance 312(b) corresponding to the second received pulse. In the example illustrated in FIG. 3B, the first distance from the LIDAR system 308(a) can be about 0.5 m, the second distance from the LIDAR system 308(b) can be about 1 m, the determined first distance 312(a) can be about 0.24 m, and the determined first distance 312(a) can be about 0.99 m. Although the example in FIGS. 3A and 3B illustrates using a model having two received return pulses, any number of return pulses could be detected.

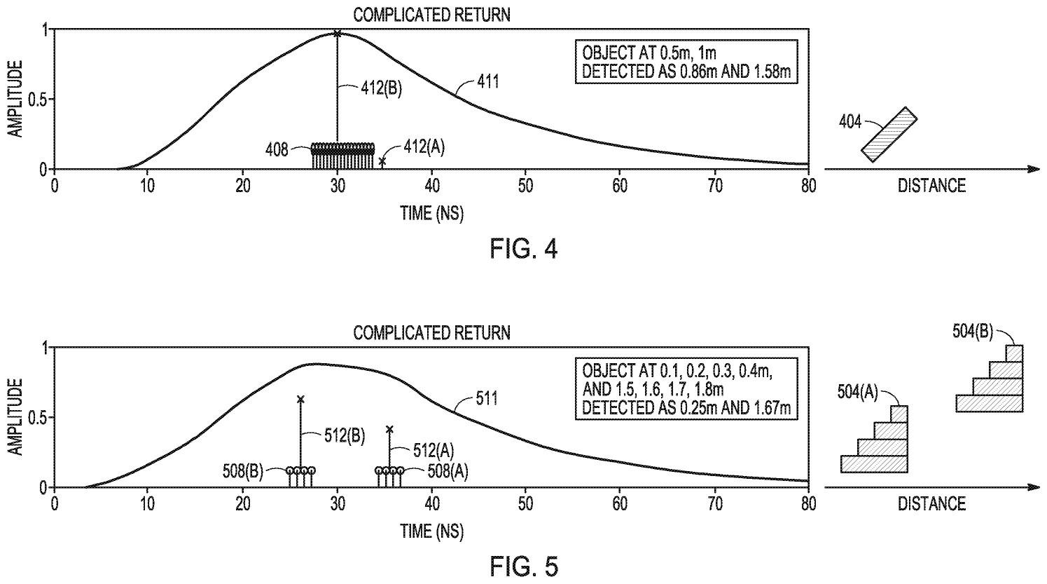

FIG. 4 illustrates an example where a feature 404 in a target region 112 can be tilted at an angle and extend over a range of distances from the LIDAR system 100. A series of light pulses can be emitted from the LIDAR system 100 toward the feature 404 in the target region 112. The photodetector 110 can detect a portion of each of the emitted light pulses, such as to determine a temporal shape of each of the emitted light pulses.

The outgoing pulses can be reflected or scattered by the feature 404 in the target region 112. The control circuitry 104 can then use the determined temporal shapes to determine an arrival time of each of the detected pulses, where the detected pulses can correspond to a received portion of the outgoing pulse scattered or reflected from feature 404. Markers 408 can represent the distances from the LIDAR system 100 to various portions of the feature 404. Each of the emitted light pulses can correspond to a different distance from the LIDAR system 100 to the feature 404. The optical system 116 and photosensitive detector 120 can receive a portion of scattered light corresponding to the emitted light pulses, such as to form a temporal profile 411 of the received light, such as that shown in FIG. 4. A time difference between light received from different portions of the feature 404 can be less than a width of each of the emitted light pulses. The control circuitry 104 can then apply a matched filter to the temporal profile of the received light. One or more parameters of the matched filter can be updated based on the temporal shapes of the emitted light pulses as determined by the photodetector 110. In the example illustrated in FIG. 4, the feature 404 can be about 1 m away from the LIDAR system 100 and the feature 404 can have an extent of about 0.5 m. The control circuitry 104 can utilize a model that includes only two received light pulses and can estimate a distance corresponding to the first received light pulse of about 0.86 m and a distance corresponding to the second received light pulse of about 1.58 m.

FIG. 5 illustrates an example where features 504(a) and 504(b) in a target region 112 can include one or more faces corresponding to different distances from the LIDAR system 100. A series of light pulses can be emitted from the LIDAR system 100 and scattered by the features 504(a) and 504(b). The photodetector 110 can detect a portion of each of the emitted light pulses, such as to determine a temporal shape of each of the emitted light pulses. Each of the emitted light pulses can correspond to a different distance from the LIDAR system 100 to the faces on features 504(a) and 504(b). The optical system 116 and photosensitive detector 120 can receive a portion of scattered light corresponding to the emitted light pulses, such as to form a temporal profile of the received light 511, such as that shown in FIG. 5.

A time difference between light received from different faces of the features 504(a) and 504(b) can be less than a width of each of the emitted light pulses. Markers 508(a) and 508(b) can represent the distances from the LIDAR system 100 to the features 504(a) and 504(b), respectively. The control circuitry 104 can then apply a matched filter to the temporal profile of the received light. One or more parameters of the matched filter can be updated based on the temporal shapes of the emitted light pulses as determined by the photodetector 110. In the example illustrated in FIG. 5, the feature 504(a) can include faces located at distances of about 0.1, 0.2, 0.3, and 0.4 m away from the LIDAR system 100 and the feature 504(b) can include faces located at distances of about 1.5, 1.6, 1.7, and 1.8 m away from the LIDAR system 100. The control circuitry 104 can utilize a model that includes only two received light pulses and, based on the received light pulses can estimate a distance to a first object 512(a) of about 0.26 m and a distance to a second object 512(b) of about 1.67 m.

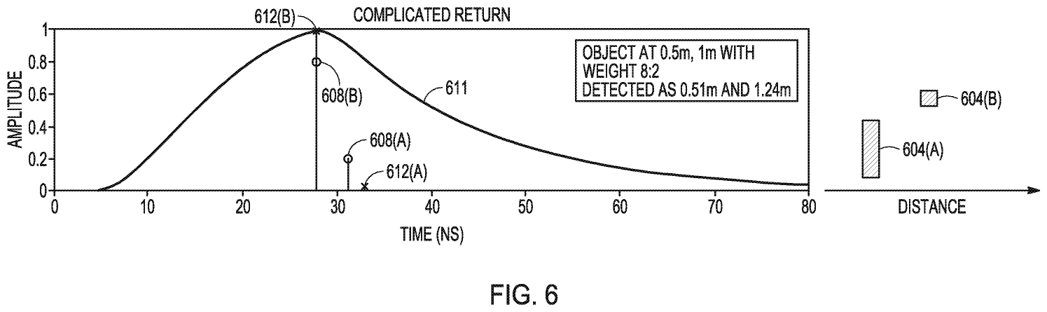

FIG. 6 illustrates an example where features 604(a) and 604(b) in the target region 112 can be at different distances from the LIDAR system 100, and can additionally extend over different distances. For example, feature 604(a) can extend over a first distance, feature 604(b) can extend over a second distance, and the first distance can be larger than the second distance by a factor (e.g., a factor of approximately 4). A series of light pulses can be emitted from the LIDAR system 100 and scattered by the features 604(a) and 604(b). The photodetector 110 can detect a portion of each of the emitted light pulses, such as to determine a temporal shape of each of the emitted light pulses.

The optical system 116 and photosensitive detector 120 can receive a portion of scattered light corresponding to the emitted light pulses, such as to form a temporal profile of the received light 511, such as that shown in FIG. 5. A number of received light pulses corresponding to feature 604(a) can be larger than a number of received light pulses corresponding to feature 604(b), such as due to feature 604(a) extending over a larger distance than feature 604(b). A time difference between light received from the features 604(a) and 604(b) can be less than a width of each of the emitted light pulses. The control circuitry 104 can then apply a matched filter to the temporal profile of the received light. One or more parameters of the matched filter can be updated based on the temporal shapes of the emitted light pulses as determined by the photodetector 110. In the example illustrated in FIG. 6, the feature 604(a) can be located at a distance of about 0.5 m away from the LIDAR system 100 and the feature 604(b) can be located at a distance of about 1 m away from the LIDAR system 100. The control circuitry 104 can utilize a model that includes only two received light pulses and, based on the received light pulses can estimate a distance to a first object of about 0.51 m and a distance to a second object of about 1.24 m.

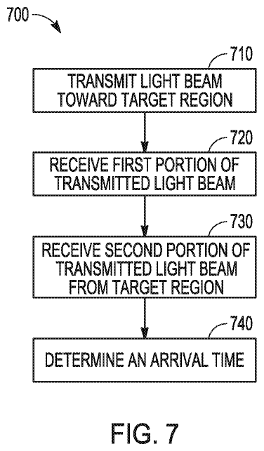

FIG. 7 illustrates an example of a method of operating a LIDAR system, such as the LIDAR system 100. At 710, one or more light pulses can be transmitted towards a target region. A photodetector can receive a first portion of the transmitted one or more light pulses, such as to determine a shape or profile of the one or more transmitted light pulses at 720. A photosensitive detector can receive a second portion of the transmitted one or more light pulses that can be reflected or scattered by the target region at 730. The shape or profile determined at 720 can be used to assist in determining a round trip travel time of the one or more light pulses transmitted towards the target region and then received by the LIDAR system after being scattered or reflected by one or more features in the target region at 740.

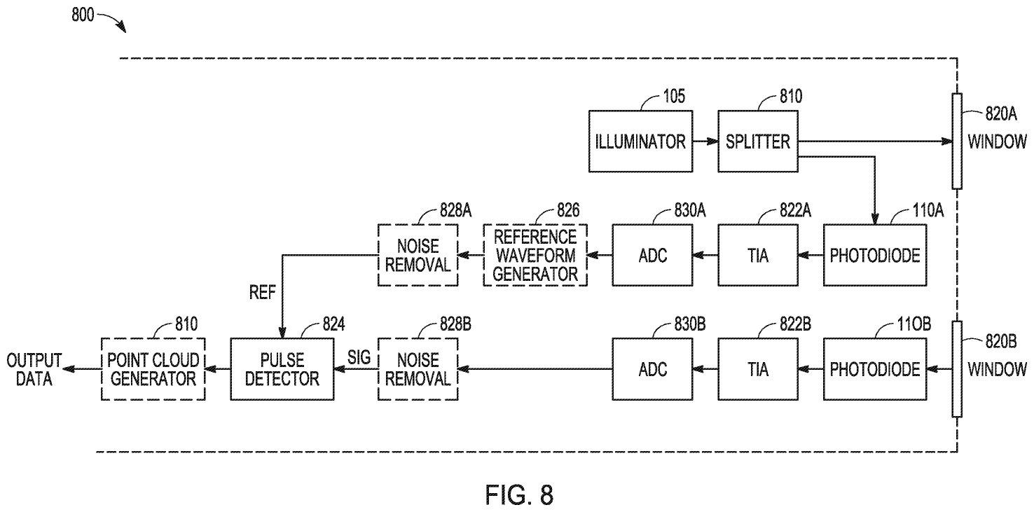

FIG. 8 illustrates an example comprising a system architecture 800 and corresponding signal flow, such as for implementing a LIDAR system as mentioned in relation to other examples herein, such as discussed in relation to FIG. 1 or in relation to operation of a LIDAR system according to other examples. In the example of FIG. 8, an illuminator 105 can be coupled to a splitter 810, such as to direct pulses of light to a first window 820A and to a detector or detector array, such as including a photodiode 110A. The splitter 810 is shown as a separate element in FIG. 8, but could be combined with the illuminator 105 assembly and could be a feature of other elements, such as reflection from the transmit window 820A. The photodiode 110A can provide an electrical signal representative of a light pulse generated by the illuminator 105 to a signal chain comprising a transimpedance amplifier (TIA) 822A and an analog-to-digital converter (ADC) 830A, to provide a digital representation of the light pulse. Such a digital representation, “REF,” can be used as a reference waveform for use in pulse detection. For example, a pulse detector can receive the digital representation, REF, and can search a signal input, SIG, to find a signal corresponding to the digital representation, REF, implementing a matched filter as mentioned in relation to other examples herein.

Light scattered or reflected by a target in response to a light pulse from the illuminator 105 can be received through a second window 820B, such as through a signal chain similar to the reference waveform signal chain. For example, the received light can be detected by a photodiode 110B, and a signal representative of the received light can be amplified by a TIA 822B and digitized by an ADC 830B. In an example, the signal chains defined by the TIAs 822A and 822B, along with photodiodes 110A and 110B, and ADCs 830A and 830B can be matched. For example, one or more of gain factor, bandwidth, filtering, and ADC timing can be matched between the two signal chains to facilitate use of the pulse detector 824 to detect scattered or reflected light pulses from the target using the locally-generated representation of the reference waveform. Pulse detector 824 may implement one or more detection techniques amongst a variety of detection techniques, such as tuned in response to the output of ADC 830A. One example includes a matched filter with coefficients that can be adjusted, such as adpatively. In another example, a threshold detection scheme can be used, such as having an adjustable threshold.

The architecture 800 can include other elements. For example, the digital representation of the reference waveform can be constructed at least in part using a reference waveform generator 826, such as by aggregating representations of several transmit pulses or performing other processing to reduce noise or improve accuracy. Noise removal can be performed such as using noise removal elements 828A and 828B, with each implementing a digital filter. Detected receive pulses can be processed such as to provide a representation of a field of regard being scanned using the

### Various Notes

Each of the non-limiting aspects above can stand on its own, or can be combined in various permutations or combinations with one or more of the other aspects or other subject matter described in this document.

The above detailed description includes references to the accompanying drawings, which form a part of the detailed description. The drawings show, by way of illustration, specific embodiments in which the invention can be practiced. These embodiments are also referred to generally as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein. In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A method for improving range resolution in an optical detection system, the method comprising:
transmitting a first light pulse towards a target region using a transmitter;
receiving a first portion of the first transmitted light pulse from the transmitter and determining a temporal profile of the first transmitted light pulse from the received first portion; and
receiving a second portion of the first transmitted light pulse from the target region and determining an arrival time of the second received portion from the target region based at least in part on the determined temporal profile of the first transmitted light pulse.

2. The method of claim 1, comprising:
adjusting a coefficient of a matched filter based at least in part on the determined temporal profile of the first transmitted light pulse; and
using the matched filter in determining the arrival time of the received second portion.

3. The method of claim 1, comprising:
receiving one or more light pulses from the target region; and
determining an arrival time of each of the one or more received light pulses based at least in part on the determined profile of the first transmitted light pulse.

4. The method of claim 3, comprising receiving one or more light pulses from a first surface in the target region and a second surface in the target region, wherein light reflected from the first surface is received at a different time than light reflected from the second surface.

5. The method of claim 4, wherein a temporal profile of light reflected from the first surface overlaps with a temporal profile of light reflected from the second surface; and wherein the method comprises determining the arrival time of the second received portion based at least in part on fitting the second received portion to the determined profile.

6. The method of claim 1, comprising transmitting one or more additional light pulses towards the target region and determining an arrival time for each of the one or more additional light pulses based at least in part on the determined profile.

7. The method of claim 6, comprising:
in response to a change in an environmental condition, updating the determined profile using at least one of the one or more additional light pulses.

8. The method of claim 6, comprising:
in response to a change in an operating condition, updating the determined profile using at least one of the one or more additional light pulses.

9. The method of claim 1, comprising:
transmitting a second light pulse towards the target region using a transmitter;
receiving a first portion of the second transmitted light pulse from the transmitter and determining a temporal profile of the second transmitted light pulse from the received first portion; and
receiving a second portion of the second transmitted light pulse from the target region and determining an arrival time of the second received portion of the second transmitted light pulse from the target region based at least in part on the determined temporal profile of the second transmitted light pulse.

10. The method of claim 1, comprising:
transmitting N−1 additional light pulses towards the target region;
receiving a first portion of each of the N−1 additional light pulses and determining a temporal profile of each of the N−1 additional light pulses;
receiving a second portion of an N^{th} transmitted light pulse from the target region and determining an arrival time of the second received portion of the N transmitted light pulse based on an average of previously determined temporal profiles.

11. An optical detection system having improved range resolution, the system comprising:
a transmitter configured to transmit a light pulse towards a target region;
a receiver configured to receive a first portion of the transmitted light pulse from the transmitter;
control circuitry configured to determine a temporal profile of the transmitted light pulse from the received first portion, wherein the receiver is configured to receive a second portion of the transmitted light pulse from the target region and the control circuitry is configured to determine an arrival time of the second received portion from the target region based at least in part on the determined temporal profile of the transmitted light pulse.

12. The system of claim 11, wherein the control circuitry is configured to adjust a coefficient of a matched filter based at least in part on the determined temporal profile of the transmitted light pulse and use the matched filter in determining the arrival time of the received second portion.

13. The system of claim 11, wherein the receiver is configured to receive one or more light pulses from the target region and wherein the control circuitry is configured to determine an arrival time of each of the one or more received light pulses based at least in part on the determined profile of the transmitted light pulse.

14. The system of claim 13, wherein the receiver is configured to receive one or more light pulses from a first surface in the target region and a second surface in the target region, wherein light reflected from the first surface is received at a different time than light reflected from the second surface.

15. The system of claim 14, wherein a temporal profile of light reflected from the first surface overlaps with a temporal profile of light reflected from the second surface; and
wherein the control circuitry is configured to determine the arrival time of the second received portion based at least in part on fitting the second received portion to the determined profile.

16. The system of claim 11, wherein the transmitter is configured to transmit one or more additional light pulses towards the target region and the control circuitry is configured to determine an arrival time for each of the one or more additional light pulses based at least in part on the determined profile.

17. The system of claim 16, wherein the control circuitry is configured to update the determined profile using at least one of the one or more additional light pulses in response to a change in an environmental condition.

18. The system of claim 16, wherein the control circuitry is configured to update the determined profile using at least one of the one or more additional light pulses in response to a change in an operating condition.

19. A system for improving range resolution in an optical detection system, the system comprising:
means for transmitting a light pulse towards a target region using a transmitter;
means for receiving a first portion of the transmitted light pulse from the transmitter and determining a temporal profile of the transmitted light pulse from the received first portion; and
means for receiving a second portion of the transmitted light pulse from the target region and determining an arrival time of the second received portion from the target region based at least in part on the determined temporal profile of the transmitted light pulse.

20. The system of claim 19, comprising:
means for adjusting a coefficient of a matched filter based at least in part on the determined temporal profile of the transmitted light pulse and using the matched filter in determining the arrival time of the received second portion.
